(19) United States
(12) Patent Application Publication
(10) Pub. No.: US 2022/0417471 A1
(43) Pub. Date: Dec. 29, 2022

(54) METHOD OF CONTROLLING A REMOTE EDUCATION CONFERENCE BY MULTIPLE PARTIES

(71) Applicant: Charles Lap San CHAN, Taipei (TW)

(72) Inventor: Tzu Te WANG, Taipei (TW)

(21) Appl. No.: 17/848,869

(22) Filed: Jun. 24, 2022

(30) Foreign Application Priority Data
Jun. 25, 2021 (TW) 110123269

(51) Int. Cl. H04N 7/15; G09B 5/10

(52) U.S. Cl. CPC H04N 7/152; G09B 5/10

(57) ABSTRACT

A method of controlling a remote education conference by multiple parties provides multiple parties with the control authority of a presenter in the same remote education conference. It is convenient for teachers and teaching assistants to control the presentation of a teaching content in the education conference. The method can help teachers customize the control authorities of teaching assistants, so that teaching assistants can flexibly assist in controlling the education conference.

This application claims priority of Application No. 110123269 filed in Taiwan on 25 Jun. 2021 under 35 U.S.C. § 119; the entire contents of all of which are hereby incorporated by reference.

### BACKGROUND OF THE INVENTION

### Field of the Invention

The present invention relates to a remote education method, particularly to a remote education method that can provide multiple parties with control authorities.

### Description of the Related Art

In today's society where Internet bandwidth has been increasing year by year, it has become the norm to use an online multi-party conference system to facilitate communication among people. One of the applications of online multi-party conferences is a remote education conference.

In a common remote education conference, a teacher usually operates the conference operation interface of a teacher terminal to control the presentation of teaching content, and a plurality of students watch the teaching content on the conference operation interfaces of student terminals in different locations. However, when a teacher faces multiple students and needs to deal with specific events at the same time, the teacher is often overwhelmed and in a hurry. For example, the teacher needs to call multiple students, the teacher needs to answer the question of a certain classmate, the teacher needs to remind a certain student of concentrating on the class, the teacher needs to control the slides to turn pages while teaching, etc.

In view of the foregoing description, teachers still have many troubles and inconveniences in order to deal with many students at the same time in a remote education conference. Therefore, how to improve and provide a fast and convenient solution has become the researching direction of those skilled in the art.

### SUMMARY OF THE INVENTION

The primary objective of the present invention provides a method of controlling a remote education conference by multiple parties, which provides multiple parties with the control authority of a presenter in the same remote education conference. It is convenient for teachers and teaching assistants to control the presentation of a teaching content in the education conference.

Another objective of the present invention provides a method of controlling a remote education conference by multiple parties, which allows teachers to customize the control authorities of teaching assistants, so that teaching assistants can flexibly assist in controlling the education conference.

In order to achieve the foregoing objectives, the present invention provides a method of controlling a remote education conference by multiple parties, which includes:
Step (A): by a first user, entering the remote education conference with a first account, wherein the first account controls presentation of a first teaching content provided by the first user according to a first control authority, and adjusting a conference operation interface of the first user according to a setting content of the first control authority;
Step (B): by the first user, setting a second control authority of a second account of a second user;
Step (C): adjusting a conference operation interface of the second user according to a setting content of the second control authority; and
Step (D): by the first user and the second user, respectively controlling presentation of the first teaching content in the remote education conference according to the first control authority and the second control authority.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a system of controlling a remote education conference by multiple parties according to a preferred embodiment of the present invention;

FIG. 2 is a flowchart of a method of controlling a remote education conference by multiple parties according to a preferred embodiment of the present invention;

FIG. 3 is a flowchart of a method of controlling a remote education conference by multiple parties according to another preferred embodiment of the present invention;

FIG. 4 is a schematic diagram illustrating the conference operation interface of a teacher terminal according to a preferred embodiment of the present invention; and

FIG. 5 is a schematic diagram illustrating the conference operation interface of a student terminal according to a preferred embodiment of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementation manners cover the characteristics of a number of specific embodiments and the steps and sequences of the method used to construct and operate these specific embodiments. However, other specific embodiments can also be used to achieve the same or equal functions and sequence of steps.

The present invention provides a method of controlling a remote education conference by multiple parties. The method provides multiple parties with the control authority of a presenter in the same remote education conference. It is convenient for teachers and teaching assistants to control the presentation of a teaching content in the education conference. The method can help teachers customize the control authorities of teaching assistants, so that teaching assistants can flexibly assist in controlling the education conference.

Before explaining the content of the present invention, the related terms and definitions are introduced as follows:

REMOTE EDUCATION SYSTEM: A computer system, used to hold a remote education conference for teaching between teachers and students, authenticates the control authorities of the teacher account and the student account, and presents the corresponding conference operation interfaces of the teacher terminal and the student terminal respectively, and transmits information such as teaching videos, teaching materials, or student videos between the teacher terminal and the student terminal according to commands sent by the conference operation interface.
CONFERENCE OPERATION INTERFACE OF TEACHER TERMINAL: Teachers can operate the conference operation interface to control the teaching content to be presented. The conference operation interface can display a list of students for roll call, hold a video/voice conference for interactive discussions with students, or optionally create text chatting rooms for discussion.
TEACHER-TERMINAL DEVICE: It can be a desktop computer, a notebook computer, a tablet computer, or an electronic device such as a smart phone. The teacher-terminal device has a microphone and a camera for capturing the teacher's voices and videos, an input device for controlling the conference operation interface of the teacher terminal, and a display device for displaying the conference operation interface of the teacher terminal.
CONFERENCE OPERATION INTERFACE OF TEACHING ASSISTANT TERMINAL: According to the control authority of the teaching assistant, the style of the conference operation interface is determined. The teaching assistant can operate the conference operation interface to control the teaching content to be presented. The conference operation interface can display a list of students for roll call, hold a video/voice conference for interactive discussions with students, or optionally create text chatting rooms for discussion.
TEACHING ASSISTANT-TERMINAL DEVICE: It can be a desktop computer, a notebook computer, a tablet computer, or an electronic device such as a smart phone. The teaching assistant-terminal device has a microphone and a camera for capturing the teaching assistant's voices and videos, an input device for controlling the conference operation interface of the teaching assistant-terminal, and a display device for displaying the conference operation interface of the teaching assistant-terminal.
CONFERENCE OPERATION INTERFACE OF STUDENT TERMINAL: It has the preset style of a conference operation interface, which is used to receive and display the teaching content provided by the teacher or teaching assistant and watched by students, control the manner of presenting the teaching content, or selectively enter the text chatting room to discuss with teachers, teaching assistants or classmates.
STUDENT-TERMINAL DEVICE: It can be a desktop computer, a notebook computer, a tablet computer, or an electronic device such as a smart phone. The student-terminal device has a microphone and a camera for capturing the student's voices and videos, an input device for controlling the conference operation interface of the student terminal, and a display device for displaying the conference operation interface of the student terminal.
TEACHING CONTENT: It includes teaching videos or teaching materials provided by teachers or teaching assistants. Wherein, the teaching videos include videos of teachers or teaching assistants in class, and the teaching materials include slides, text files or pictures.

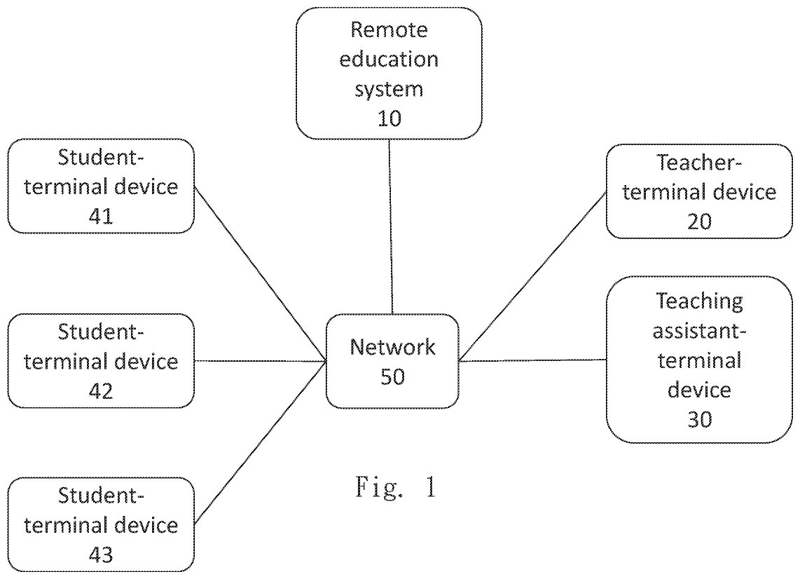

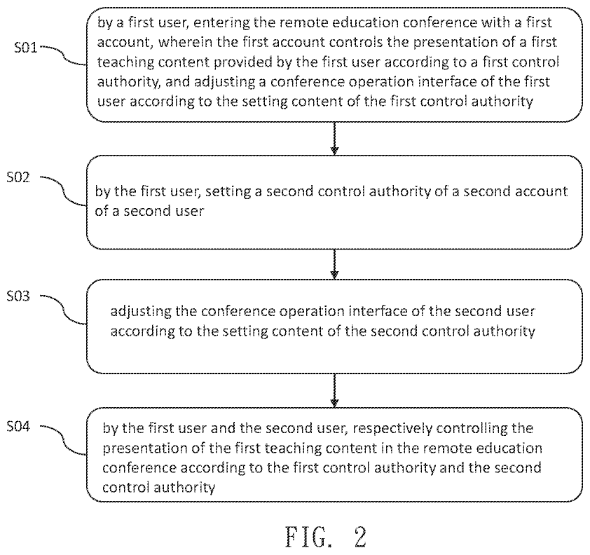

Please refer to FIG. 1 and FIG. 2 together with the following description. FIG. 1 is a schematic diagram illustrating a system of controlling a remote education conference by multiple parties according to a preferred embodiment of the present invention. FIG. 2 is a flowchart of a method of controlling a remote education conference by multiple parties according to a preferred embodiment of the present invention. In FIG. 1, a remote education system 10 can be implemented with a computer server or a group of computer servers. A teacher-terminal device 20, a teaching assistant-terminal device 30, and student-terminal devices 41, 42, and 43 can be electronic devices, such as desktop computers, laptop computers, tablet computers, or smartphones. The remote education system 10, the teacher-terminal device 20, the teaching assistant-terminal device 30, and the student-terminal devices 41, 42, and 43 are connected to each other via a network 50.

In FIG. 2, the method of controlling a remote education conference by multiple parties is introduced as follows. In Step S01, a first user enters a remote education conference with a first account, wherein the first account controls the presentation of a first teaching content provided by the first user according to a first control authority, and a conference operation interface of the first user is adjusted according to the setting content of the first control authority. In an embodiment of the present invention, the first user may be a teacher. The teacher uses the teacher-terminal device 20 to enter the remote education conference with a teacher account. The remote education conference is held by the remote education system 10. The conference operation interface (not illustrated but will be further explained later) of a teacher terminal may be produced by an application program installed in the teacher-terminal device 20 that can hold the remote education conference. The conference operation interface of the teacher terminal may be produced by the remote education system 10 and displayed in a web browser on the teacher-terminal device 20, but the present invention is not limited thereto. The first teaching content includes teaching videos prepared by the teacher, teaching materials prepared by the teacher, or a combination of these. According to the control authority, the teacher can control whether to present teaching video of the teacher, teaching materials of the teacher, or a combination of these.

The control authority of the teacher account can be preset to be the most complete control authority, such as the authority of the presenter of the remote teaching conference. The conference operation interface of the teacher terminal will adjust the conference operation interface according to the setting content of the control authority of the teacher account. For example, if the control authority includes playing the teacher's teaching video, the conference operation interface will display a button to turn on the camera. If the control authority includes displaying teaching materials (e.g., slides, text files, or pictures, etc.) that the teacher intends to use in class, the conference operation interface will display a button to open the teaching materials. If the control authority includes setting the control authorities of other users, the conference operation interface will display buttons that can enable selection of other users and check the control authorities of each user. If the control authority includes restricting what teaching contents available to students, the conference operation interface will display a button to restrict teaching contents. It should be understood that the control authority of the present invention is not limited to these, and that the presentation of the conference operation interface is not limited to buttons.

In Step S02 of FIG. 2, the first user sets a second control authority of a second account of a second user. In an embodiment of the present invention, the teacher operates the conference operation interface of the teacher terminal to set the control authority of the teaching assistant account of the teaching assistant with the teacher account. Specifically, the teacher can select one of students that participant in the education conference as the teaching assistant. In other words, the account of the student becomes the account of the teaching assistant. Then, the teacher sets the control authority of the teaching assistant. The control authority of the teaching assistant includes whether to display teaching videos of a user, whether to display teaching materials of a user, whether to set control authorities of other users, whether to restrict teaching contents watched by students, or a combination of these, but the present invention is not limited thereto. When the teacher operates the conference operation interface of the teacher terminal to complete the setting, the teacher-terminal device 20 sends a corresponding command to notify the remote education system 10. The remote education system 10 correspondingly changes the control authority of the account of the teaching assistant.

In Step S03 of FIG. 2, the conference operation interface of the second user is adjusted according to the setting content of the second control authority. As mentioned above, the teaching assistant is one of students that participant in the remote education conference. As a result, the conference operation interface of the teaching assistant is the conference operation interface of the student terminal (explained later). When the teacher selects the teaching assistant and sets the control authority of the teaching assistant, the remote education system 10 adjusts the conference operation interface of the student terminal into the conference operation interface of the teaching assistant terminal according to the setting content of the control authority of the teaching assistant. For example, if the control authority of the teaching assistant set by the teacher includes playing the teaching video of the teacher in class, the conference operation interface will display a button to turn on the camera. If the control authority includes displaying teaching materials (e.g., slides, text files, or pictures, etc.) that the teacher intends to use in class, the conference operation interface will display a button to open the teaching materials. If the control authority includes setting the control authorities of other users, the conference operation interface will display buttons that can select other users and check the control authorities. If the control authority includes restricting teaching contents watched by students (e.g., restricting students to watch only the teacher's teaching video at this time, or restricting students to watch only the teaching materials at this time), the conference operation interface will display a button to restrict teaching contents. It should be understood that the control authority of the present invention is not limited to these, and that the presentation of the conference operation interface is not limited to buttons.

In Step S04 of FIG. 2, the first user and the second user respectively control the presentation of the first teaching content in the remote education conference according to the first control authority and the second control authority. For example, the teacher may operate the teacher-terminal device 20 to turn on the camera for the needs of the class, so that the students can watch the teacher's teaching video. At the same time, in order for the students to understand the content and assist in learning, the teacher also opens a slideshow file for the students to watch. In other words, the teacher provides two teaching contents. Depending on the emphasis that the teacher intends to talk about, the teacher may only want the students to watch the teacher's teaching video at this time. Then, the teacher can operate teacher-terminal device 20 to transmit only the teacher's teaching video to the remote education system 10 through the conference operation interface of the teacher terminal. The remote education system 10 transmits the teacher's teaching video to the student-terminal devices 41, 42, and 43, so that the students can only receive the teacher's teaching video. When the teacher wants the students to mainly watch the slideshow file at this time, the teacher should control the remote education system 10 to increase the aspect ratio of the slide file and decrease the aspect ratio of the teacher's teaching video through the conference operation interface of the teacher terminal. The conference operation interface of the teacher terminal then transmits corresponding commands to the remote education system 10, so that the remote education system 10 can control the student-terminal devices 41, 42, and 43 of the students to receive a larger slide image. The students can still see and hear the teacher's explanation with the smaller teacher's teaching video. It should be understood that the teaching assistant can also operate the teaching assistant terminal device 30 to perform the foregoing control on the conference operation interface of the teaching assistant terminal according to the control authority in Step S04. In other words, both the teacher and the teaching assistant can control the presentation of the teaching content in the remote education conference. Therefore, when the teacher needs to concentrate on the class, the teacher does not need to control the presentation of the teaching content by himself/herself. Instead, the teaching assistant can control the presentation of the teaching content so that the teacher can concentrate more on the class.

In another embodiment of the present invention, the second account controls the presentation of a second teaching content provided by the second user according to the second control authority in Step S03. For example, when setting the control authority of the teaching assistant, the teacher agrees to display the teaching video of the teaching assistant, display the teaching materials of the teaching assistant, set the control authorities of other users, and restrict teaching contents watched by students. Since account of the teaching assistant has the foregoing control authority, the teaching assistant can operate the teaching assistant-terminal device 30 to transmit the teaching content provided by the teaching assistant to the remote education conference of the remote education system 10 through the conference operation interface of the teaching assistant terminal. The remote education conference of the remote education system 10 can present the teaching content. The teaching content can include the teaching videos of the teaching assistant, the teaching materials of the teaching assistant, or a combination of these. In addition, if the teaching assistant is temporarily unable to assist the teacher, the teaching assistant can also select one of the students from the list of students participating in the education conference as the second teaching assistant (because the teaching assistant can set the control authority of other users). In other words, the student's account becomes the account of the second teaching assistant. Then, the teaching assistant sets the control authority given to the account of the second teaching assistant. The conference operation interface of the student is adjusted into the conference operation interface of the teaching assistant terminal according to the setting content of the control authority.

When the second account controls presentation of a second teaching content provided by the second user according to the second control authority in Step S03, the first user and the second user respectively control presentation of the first teaching content and the second teaching content in the remote education conference according to the first control authority and the second control authority in Step S04. For example, the teacher operates the teacher-terminal device 20 to provide two teaching contents including the teacher's teaching video and the teacher's teaching material through the conference operation interface of the teacher terminal. The teaching assistant also operates the teaching assistant-terminal device 30 to provide two teaching contents including the teaching video and the teaching material of the teaching assistant through the conference operation interface of the teaching assistant terminal. Then, the teacher and the teaching assistant can control the presentation of the teaching videos and the teaching materials of the teacher and the teaching assistant in the remote education conference according to their control authorities. It should be noted that the teacher and the teaching assistant can also control each other's teaching videos or teaching materials. For example, if the teacher is unable to continue teaching in the class, the teaching assistant can operate the teaching assistant-terminal device 30 to provide the teaching video of the teaching assistant through the conference operation interface of the teaching assistant terminal. Thus, the class is continued. The teaching assistant can operate the teaching assistant-terminal device 30 to control the teaching materials (such as slides) provided by the teacher and the teacher-terminal device 20 to turn pages and so on.

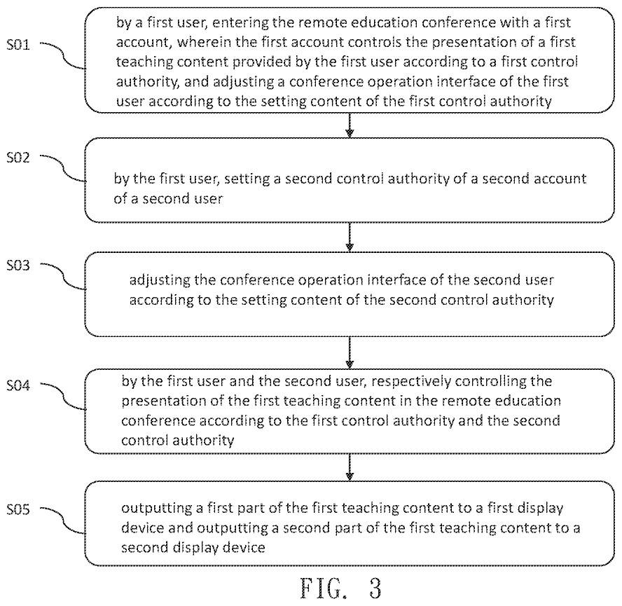

FIG. 3 is a flowchart of a method of controlling a remote education conference by multiple parties according to another preferred embodiment of the present invention. Steps S01-S04 of FIG. 3 are the same to those of FIG. 2 so will not be reiterated. In Step S05 of FIG. 3, a first part of the first teaching content is outputted to a first display device and a second part of the first teaching content is outputted to a second display device. In the remote education conference, the teacher may provide one or more different teaching contents (such as the teaching video of the teacher and the teaching material of the teacher). In order to avoid the inconvenience caused by the need that the teacher frequently switches and watches different teaching contents, the teacher can operate the display device of the teacher-terminal device 20 to display the first part of the teaching content (such as the teacher's teaching video) through the conference operation interface, and operate an external display device (such as a computer screen, a digital TV, etc.) connected to the teacher-terminal device 20 to display the second part of the teaching content (such as the teacher's teaching material), but the present invention is not limited thereto. Similarly, in order to avoid the inconvenience caused by the need that the teaching assistant frequently switches and watches different teaching contents, the teaching assistant can also operate the display device of the teaching assistant-terminal device 30 to display the first part of the teaching content (such as the teaching video of the teaching assistant) through the conference operation interface, and operate an external display device (such as a computer screen, a digital TV, etc.) connected to the teaching assistant-terminal device 30 to display the second part of the teaching content (such as the teaching material of the teaching assistant).

In an embodiment of the present invention, a part of the conference operation interface of the teacher terminal is used to display a list of students. In order to save the network bandwidth, the video of each student will not be displayed on the conference operation interface of the teacher terminal. However, in order to make the teacher care about the class situation of students in real time, the teacher can operate the conference operation interface of the teacher terminal to ask any student in the remote education conference to send his/her video to the conference operation interface of the teacher terminal, such that the conference operation interface of the teacher terminal displays the video of the student. For example, when the teacher operates the conference operation interface of the teacher terminal of the teacher-terminal device 20 to selects one of students in the list of students, the conference operation interface will send a command to the remote education system 10. The remote education system 10 will ask the student-terminal device (e.g., the student-terminal device 41) to return the video of the student. Then, the remote education system 10 transmits the student's video to the conference operation interface of the teacher terminal of the teacher-terminal device 20, such that the conference operation interface of the teacher terminal of the teacher-terminal device 20 displays the student's video. It should be understood that then the teaching assistant can also operate the conference operation interface of the teaching assistant terminal of the teaching assistant-terminal device 30 to ask to display the video of a student if the control authority set by the teacher and given to the account of the teaching assistant also includes asking to display the video of a student.

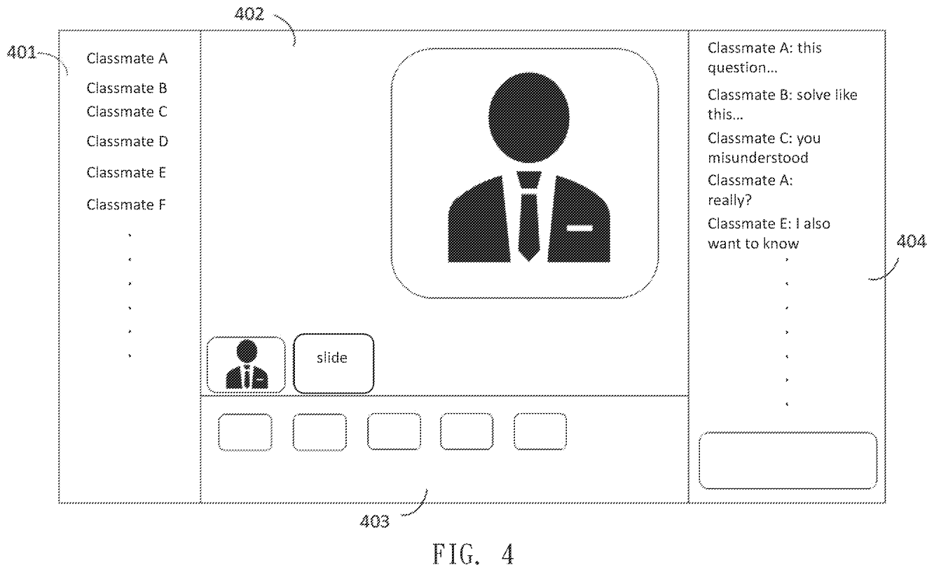

FIG. 4 is a schematic diagram illustrating the conference operation interface of a teacher terminal according to a preferred embodiment of the present invention, wherein the conference operation interface includes a student list area 401, a teaching content area 402, an operation button area 403, and a chatting area 404. The student list area 401 can list the names of students in class, so that the teacher can check whether the students are online or not, and can also click the student's name to ask the remote education system 10 to notify the student's student-terminal device of returning the student's video. The teaching content area 402 can display the teaching contents provided by the teacher. For example, the current teacher has provided the teaching videos of the teacher and the teaching materials of the teacher. The teaching content area 402 can display the thumbnails of different teaching contents in the lower left corner. When the teacher clicks on the thumbnail of the teaching content, the teaching content will be enlarged and presented. For example, the teacher chooses to enlarge and present the teaching video of the teacher. The operation button area 403 includes a plurality of buttons corresponding to the control authority. For example, if the control authority includes displaying the teaching videos of the teacher in class, the conference operation interface will displays a button that can turn on the camera. If the control authority includes displaying the teaching materials (such as slides, text files or pictures, etc.) that the teacher intends to use in class, the conference operation interface will displays a button that can open the teaching materials. If the control authority includes setting the control authorities of other users, the conference operation interface display buttons that can select other users and check the control authorities. If the control authority includes restricting teaching contents watched by students, the conference operation interface will display a button to restrict teaching contents. It should be understood that the control authority of the present invention is not limited to these. The chatting area 404 displays a text chatting room. The upper part of the text chatting room can present everyone's chatting content, and the lower part of the text chatting room can input text to facilitate communication with other people. It should be understood that the conference operation interface of the teacher terminal in FIG. 4 is used for illustration purposes only. The conference operation interface of the teacher terminal of the present invention can also be implemented in other manners. In addition, the implementation of the conference operation interface of the teaching assistant terminal is similar to that of the conference operation interface of the teacher terminal in FIG. 4. However, the buttons in the operation button area 403 of the conference operation interface of the teaching assistant terminal are different from those of the teacher terminal due to the difference of the control authority of the teaching assistant set by the teacher. For example, if the teacher sets that the teaching assistant cannot display the teaching materials (such as slides, text files or pictures, etc.) to be used in the class, the conference operation interface will not display the button to open the teaching materials.

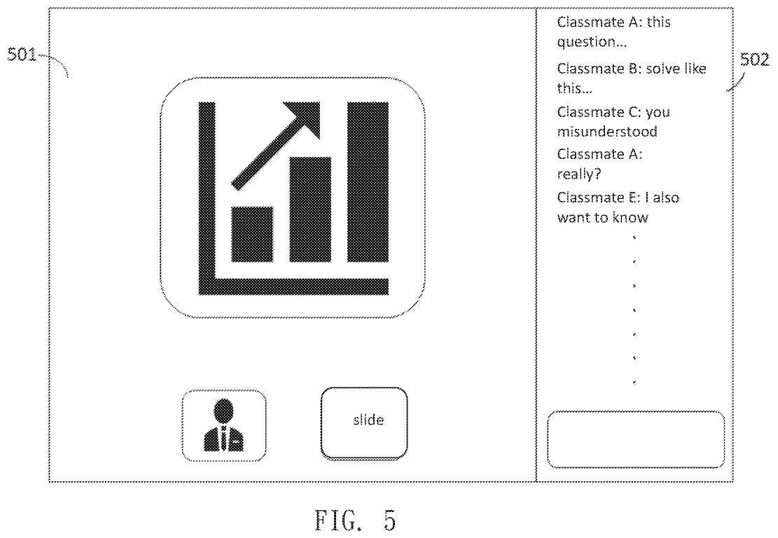

FIG. 5 is a schematic diagram illustrating the conference operation interface of a student terminal according to a preferred embodiment of the present invention, wherein the conference operation interface includes an teaching content area 501 and a chatting area 502. The teaching content area 501 can display the teaching contents provided by the teacher. For example, the current teacher has provided the teaching videos of the teacher and the teaching materials of the teacher. The teaching content area 501 can display the thumbnails of different teaching contents in the lower left corner. When the student clicks on the thumbnail of the teaching content, the teaching content will be enlarged and presented. For example, the student chooses to enlarge, present, and watch the teaching material of the teacher. The chatting area 502 displays a text chatting room. The upper part of the text chatting room can present everyone's chatting content, and the lower part of the text chatting room can input text to facilitate communication with other people.

According to the forgoing description, it is understood that the present invention provides a method of controlling a remote education conference by multiple parties, which provides multiple parties with the control authority of a presenter in the same remote education conference. It is convenient for teachers and teaching assistants to control the presentation of a teaching content in the education conference. The method of the present invention can help teachers customize the control authorities of teaching assistants, so that teaching assistants can flexibly assist in controlling the education conference.

Although various examples of the disclosed technology have been described above, it should be understood that these examples have been presented by examples rather than limited. Likewise, various drawings may depict example architectures or other configurations of the disclosed technology. The drawings may be depicted to assist in understanding the features and functionality that may be included in the disclosed technology. The disclosed technology is not limited to the illustrated example architectures or configurations, but the desired features can be implemented using a variety of alternative architectures and configurations. In fact, it will be obvious to those skilled in the art to know how to implement alternative functionalities, logical or physical partitions and configurations to implement the required features of the technology disclosed in this article. In addition, with regard to flowcharts, operation descriptions, and methodological technical solutions, the order in which the steps are presented herein should not require that the disclosed technologies be implemented in the same order to perform the listed functionality, unless the context dictates otherwise.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method of controlling a remote education conference by multiple parties, comprising:
Step (A): by a first user, entering the remote education conference with a first account, wherein the first account controls presentation of a first teaching content provided by the first user according to a first control authority, and adjusting a conference operation interface of the first user according to a setting content of the first control authority;
Step (B): by the first user, setting a second control authority of a second account of a second user;
Step (C): adjusting a conference operation interface of the second user according to a setting content of the second control authority; and
Step (D): by the first user and the second user, respectively controlling presentation of the first teaching content in the remote education conference according to the first control authority and the second control authority.

2. The method of controlling the remote education conference by multiple parties according to claim 1, wherein the first teaching content includes teaching videos of the first user, teaching materials of the first user, or a combination of these.

3. The method of controlling the remote education conference by multiple parties according to claim 1, wherein Step (C) further comprises: the second account controls presentation of a second teaching content provided by the second user according to the second control authority.

4. The method of controlling the remote education conference by multiple parties according to claim 3, wherein the second teaching content includes teaching videos of the second user, teaching materials of the second user, or a combination of these.

5. The method of controlling the remote education conference by multiple parties according to claim 3, wherein in Step (D), the first user and the second user respectively control presentation of the first teaching content and the second teaching content in the remote education conference according to the first control authority and the second control authority.

6. The method of controlling the remote education conference by multiple parties according to claim 1, wherein the first control authority and the second control authority are identical or different.

7. The method of controlling the remote education conference by multiple parties according to claim 1, wherein the second control authority includes whether to display teaching videos of a user, whether to display teaching materials of a user, whether to set control authorities of other users, whether to restrict teaching contents watched by students, or a combination of these.

8. The method of controlling the remote education conference by multiple parties according to claim 1, wherein Step (B) further comprises: the first user operates the conference operation interface to choose a participant of the remote education conference as the second user and sets the second control authority.

9. The method of controlling the remote education conference by multiple parties according to claim 1, further comprising Step (E): outputting a first part of the first teaching content to a first display device and outputting a second part of the first teaching content to a second display device.

10. The method of controlling the remote education conference by multiple parties according to claim 1, wherein the first user operates the conference operation interface to ask any participant of the remote education conference to transmit a video of the any participant to the conference operation interface of the first user.
